(19) United States
(12) Patent Application Publication
(10) Pub. No.: US 2020/0260647 A1
(43) Pub. Date: Aug. 20, 2020

(54) ROW CROP HARVESTING HEAD

(71) Applicant: Jonathan Roemke, Harlan, IN (US)

(72) Inventor: Jonathan Roemke, Harlan, IN (US)

(21) Appl. No.: 16/792,382

(22) Filed: Feb. 17, 2020

Related U.S. Application Data
(60) Provisional application No. 62/806,151, filed on Feb. 15, 2019.

(51) Int. Cl. A01D 45/02

(52) U.S. Cl. CPC A01D 45/023

(57) ABSTRACT

A combine harvesting head includes harvesting snouts, gathering chains to pull crop stalks into the space between adjacent snouts, roller mechanisms to pull crop stalks downward away from the harvesting head, and stripper plates to strip the crop from its stalks. Each stripper plate assembly has two halves, with the first half having a stalk-contacting edge and a surface extending upward and away from that edge in a first direction, and the second half having a stalk-contacting edge and a surface extending downward and away from that edge in a second direction. The first stripper plate half is positioned at a level that is higher from the ground than the level of the corresponding second stripper plate half, and overlaps or is directly adjacent the second stripper plate half so that there is little or no horizontal gap between the two halves.

### REFERENCE TO RELATED APPLICATIONS

This application claims priority from U.S. Provisional Patent Application Ser. No. 62/806,151, filed Feb. 15, 2019, the entire contents of which is hereby incorporated herein by reference.

### FIELD OF THE INVENTION

The present invention relates generally to a harvesting head for a combine used to harvest a row crop, such as corn.

### BACKGROUND OF THE INVENTION

Prior art combines use a harvesting head mounted to the front of the combine. The harvesting head has a series of snouts that travel down the rows of the crop to direct the individual plant stalks into the head.

The spaces between the snouts contain three main components. The first component is a pair of gathering chains that assist in pulling the stalks into the head. Typically left and right gathering chains are used, and those chains cooperate to pull the stalks into the spaces between the snouts.

Adjacent the gathering chains are stripper plates that are spaced apart a distance that is great enough to allow stalks to pass between the gaps between the plates. The stripper plates may be above or below the gathering chains, but are always spaced apart a distance that is wide enough to accommodate the corn stalks, but narrow enough to prevent corn cobs from passing through the gaps between the plates.

Below the gathering chains are rollers that pull the stalks downward. The downward pulling action is used to strip the crop from the stalk.

As the plant is pulled into the head by the gathering chains, and as the stalk is pulled down by the rollers, the cob hits the stripper plates. Again, the stripper plates are spaced to allow the stalk—but not the cob—to pass through.

As the combine continues to move forward, the cob moves toward the combine—where it is moved by an auger to the subsequent functional portions of the combine.

With prior art harvesting heads some kernels are lost when they are not captured by the stripper plates and accordingly fall to the ground. These “header” or “gathering” losses usually contribute the most to harvesting losses because whole ears as well as kernels can be lost at the header. By some estimates, up to 10 bu/acre, or even more, are lost at the harvesting head by standard corn harvesting technology.

A need therefore exists for a row crop harvesting head that prevents gathering losses. The present invention addresses that need.

### SUMMARY OF THE INVENTION

Briefly describing one aspect of the present invention, there is provided a row crop harvesting head mountable to a combine in a manner effective to harvest row crops in a field. The harvesting head comprises a plurality of spaced-apart harvesting snouts, gathering chains effective for pulling row crop stalks into a space between adjacent harvesting snouts, roller mechanisms effective for pulling row crop stalks downward away from the harvesting head and toward the ground, and a plurality of stripper assemblies effective for stripping the row crop from its stalks.

Each of the stripper assemblies comprises a pair of adjacent halves, with each pair of adjacent halves comprising a first half having a first stalk-contacting edge and/or roller and a first plate surface extending away from that stalk-contacting edge and/or roller in a first direction, and a second half having a second stalk-contacting edge and/or roller and a second plate surface extending away from that stalk-contacting edge and/or roller in a second direction opposite said first direction. Each of the first stalk-contacting halves is positioned on the harvesting head at a first stalk-contacting level, and each of the second stalk-contacting halves is positioned on the harvesting head at a second stalk-contacting level, with each of the first stalk-contacting edge levels being higher from the ground than its corresponding second stalk-contacting edge level. Each of the stalk-contacting halves is positioned on the harvesting head at a horizontal position in which the first stalk-contacting edge overlaps or is directly adjacent the second stalk-contacting edge so that there is little or no horizontal gap between the two halves.

In some embodiments the first plate surfaces slope upward as they extend away from their stalk-contacting edge.

In some embodiments the second plate surfaces slope downward as they extend away from their stalk-contacting edges.

In some embodiments the second plate surfaces extend away from their second stalk-contacting edges until they terminate in a trough portion.

### BRIEF DESCRIPTION OF THE DRAWINGS

FIG. 1 is a perspective view of a corn harvesting combine with a corn harvesting head at the front of the combine.

FIG. 2 shows a stripper plate that may be used with corn harvesting heads.

FIG. 3 shows a roller mechanism that may be used with corn harvesting heads.

FIGS. 4A, 4B, 4C, and 4D show how corn stalks are pulled by the roller mechanism down past the stripper plates, and how the harvested corn ear is retained by the stripper plates before being moved to the combine storage bin.

FIGS. 5A and 5B show an end sectional view of a prior art stripper plate assembly, with the two halves of the stripper plate being aligned with respect to the y-axis, and spaced apart with respect to the x-axis.

FIG. 6 shows an end sectional view of the stripper plate assembly of one embodiment of the present invention.

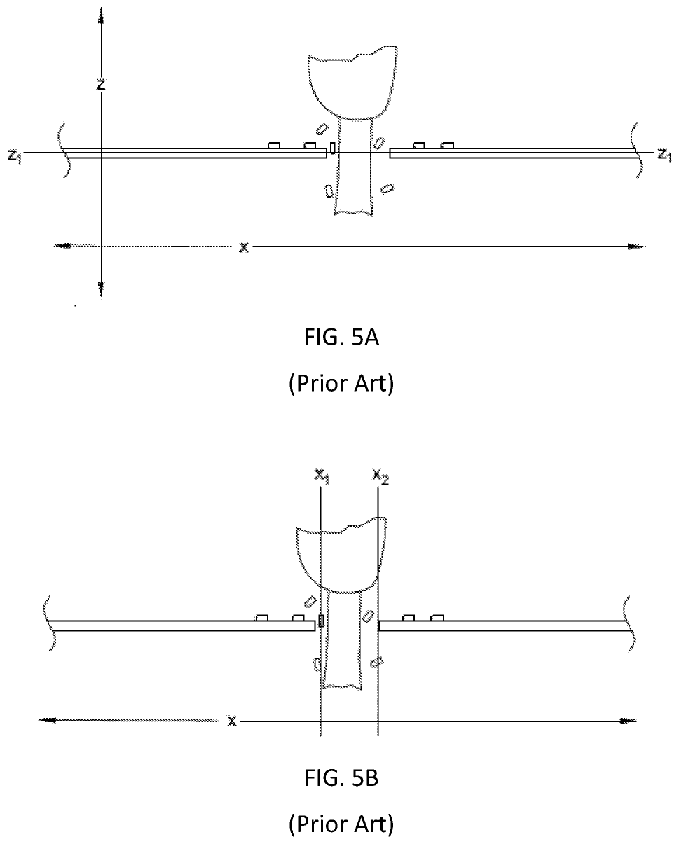

FIGS. 7A and 7B show an end sectional view of a stripper plate assembly according to one embodiment of the present invention, with one half of the stripper plate assembly being positioned above the other half with respect to the z-axis, and the two halves overlapping or being directly adjacent to each other with respect to the x-axis so that there is not a substantial space between the two halves along the x-axis, and with the lower half of the stripper plate assembly including a trough at its lower end to collect kernels and to pass them back to an auger.

FIG. 8 shows a gathering mechanism that may be used with corn harvesting heads.

FIG. 9 shows how components mounted on the right-hand side or one snout cooperate with components mounted on the left-hand side of an adjacent snout to harvest a row crop.

FIGS. 10A and 10B show one preferred embodiment of a gathering mechanism that may be used with the inventive corn harvesting heads.

FIG. 11 shows one embodiment of a stripper roller mechanism useful with some embodiments of the present invention.

### DESCRIPTION OF THE PREFERRED EMBODIMENTS

For the purposes of promoting an understanding of the principles of the invention, reference will now be made to certain embodiments and specific language will be used to describe the same. It will nevertheless be understood that no limitation of the scope of the invention is thereby intended, such alterations and further modifications in the described device, and such further applications of the principles of the invention as illustrated therein, being contemplated as would normally occur to one skilled in the art to which the invention relates.

As indicated above, one aspect of the present invention relates to a row crop harvesting head mountable to a combine in a manner effective to harvest row crops in a field. Such machines are used to harvest crops, such as corn, which are grown in even rows on tall stalks.

The inventive harvesting head comprises a plurality of spaced-apart harvesting snouts. The snouts are typically arranged in a line across the front of the combine, and are spaced apart a distance effective for harvesting crops planted in rows. Accordingly, the space between adjacent snouts corresponds to the distance between crop rows, so that when the combine travels through the field each row of the crop is centered between adjacent snouts. As the combine travels through the field, the row of crops passes through the space between adjacent snouts according to the speed at which the combine is being driven.

The inventive harvesting head comprises a plurality of roller mechanisms effective for pulling row crop stalks downward away from the harvesting head and toward the ground as the harvesting head passes over the crop. Typically each snout holds two roller mechanisms, namely, a left roller mechanism and a right roller mechanism. The left roller mechanism of one snout cooperates with the right roller mechanism of an adjacent snout to pull row crop stalks downward away from the harvesting head and toward the ground.

The inventive harvesting head also comprises a plurality of stripper assemblies effective for stripping the row crop from its stalks as the crop stalk is pulled downward by the rollers. Each stripper assembly comprises a pair of adjacent halves. In a manner similar to the roller mechanisms, the two halves are normally attached to adjacent snouts, with each snout having the left (and preferably upper) half of one stripper assembly, and the right (and preferably lower) half of another stripper plate assembly. In this manner the left/upper half of one stripper assembly and the right/lower half of another stripper assembly may cooperate to strip the row crop from its stalk as the stalk passes through the space between two snouts.

To perform the crop stripping action, each pair of adjacent halves may comprise a stalk-contacting edge and a plate surface extending away from it. For example, the left stripper assembly half may have an upper stalk-contacting edge and an upper plate surface extending upward and outward from that edge in a first direction, and the right stripper assembly half may have a lower stalk-contacting edge and a lower plate surface extending downward and outward away from that edge in a second direction opposite said first direction.

In a further embodiment, each stripper assembly may have a stalk-contacting roller and a plate surface extending away from it. For example, the left stripper assembly half may have an upper stalk-contacting roller and an upper plate surface extending upward and outward from that roller in a first direction, and the right stripper assembly half may have a lower stalk-contacting roller and a lower plate surface extending downward and outward away from that roller in a second direction opposite said first direction.

In the inventive stripper assembly, each of the first stalk-contacting halves is positioned on the harvesting head at a first, upper stalk-contacting level, and each of said second stalk-contacting halves is positioned on the harvesting head at a second, lower stalk-contacting level. As suggested by the name, and as shown in the drawings, the first, upper stalk-contacting edge or roller level is higher (i.e., farther from the ground) than its corresponding second, lower stalk-contacting edge or roller level.

Also in the inventive stripper plate assembly, each of the stalk-contacting halves is positioned on the harvesting head at a horizontal position in which the first stalk-contacting edge or roller overlaps, or is directly adjacent to, the second stalk-contacting edge or roller. With this arrangement there is little or no horizontal gap between the two halves.

In the preferred inventive stripper plate assemblies, each of the second plate surfaces slopes downward as it extends away from its stalk-contacting edge or roller. Similarly, each of the first plate surfaces preferably slopes upward as it extends away from its stalk-contacting edge or roller. With this arrangement, the stripper plate assembly slopes downward from the upper left portion of the assembly to the lower right portion of the assembly, thus providing a smooth pathway for crop to be directed to its initial collection area.

To facilitate collection of the crop, each of the second plate surfaces preferably extends away from its second stalk-contacting edge until it terminates in a trough portion. The trough may further slope backward toward an auger to facilitate collection of the crop.

The inventive harvesting head may also comprise a gathering mechanism effective for sweeping harvested row crop from the trough portion of the lower stripper plate assembly to an auger or other device effective for removing harvested crop from the harvesting head and directing it to a storage bin. The gathering device typically comprises paddles or other sweeping surfaces effective for sweeping harvested crop, and is preferably located directly above the trough on the lower side of the stripper plate assembly.

It is to be appreciated that the present invention includes embodiments in which the harvesting head comprises a plurality of spaced-apart harvesting snouts, a plurality of roller mechanisms effective for pulling row crop stalks downward away from the harvesting head and toward the ground in a space between adjacent snouts, and a plurality of stripper plate assemblies effective for stripping the row crop from its stalks as the stalks are pulled downward past the stripper plates. In the most preferred embodiments all of those stripper plate assemblies comprise a pair of adjacent halves, with each pair of adjacent halves comprising a first half having a first stalk-contacting edge and a first plate surface extending away from said first stalk-contacting edge in a first direction, and a second half having a second stalk-contacting edge and a second plate surface extending away from said second stalk-contacting edge in a second direction opposite said first direction. Similarly, most preferably all of the first stalk-contacting halves is positioned on the harvesting head at a first stalk-contacting level, and all of the second stalk-contacting halves are positioned on the harvesting head at a second stalk-contacting level, with each of said first stalk-contacting edge levels being higher from the ground than its corresponding second stalk-contacting edge level. Also similarly, it is preferred that all of the stalk-contacting halves are positioned on the harvesting head at a horizontal position in which the first stalk-contacting edge overlaps or is directly adjacent the second stalk-contacting edge so that there is little or no horizontal gap between the two halves. However, in some less preferred embodiments the inventive stripper plate assemblies may be provided on harvesting heads with additional stripper plate assemblies that do not have some or all of these features, and are instead conventionally arranged.

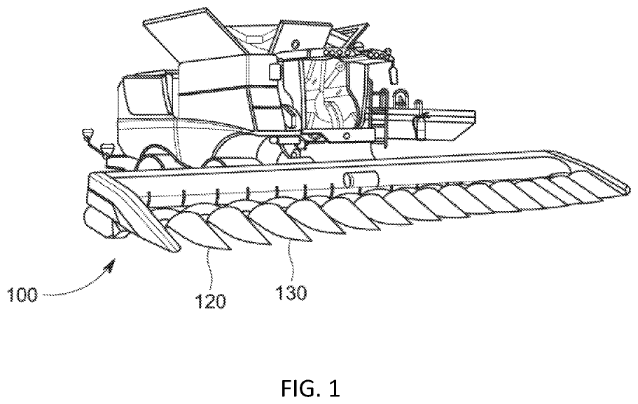

Referring now to the drawings, FIG. 1 is a perspective view of a corn harvesting combine with a corn harvesting head at the front of the combine. Harvesting head 110 is mounted to combine 100 so that the harvesting head is positioned to harvest corn from a field. Snouts 120 are arranged in a line across the front of the combine, and are spaced apart a distance effective for harvesting crops planted in rows. The inter-snout space 130 between adjacent snouts corresponds to the distance between crop rows, so that when the combine travels through the field each row of the crop is centered between adjacent snouts.

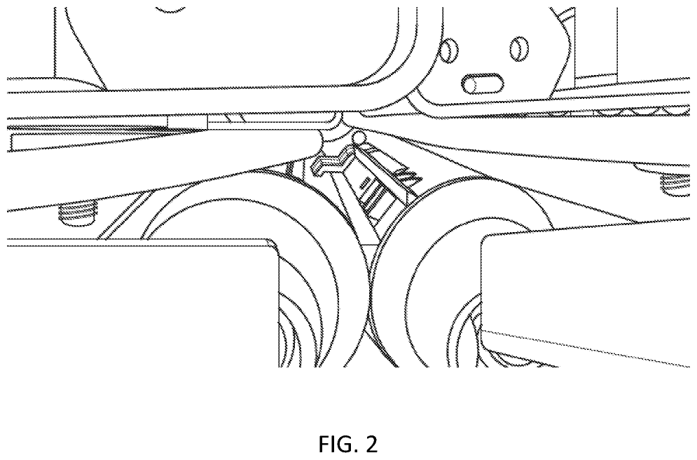

FIG. 2 shows a prior art stripper plate assembly that may be used with corn harvesting heads. As previously indicated, each plate assembly comprises a pair of adjacent halves. The two halves are normally attached to adjacent snouts, with each snout having the left half of one stripper plate assembly, and the right half of another stripper plate assembly. In this manner the left half of one stripper plate assembly and the right half of another stripper plate assembly cooperate to strip the row crop from its stalk as the stalk passes through the space between two snouts and is pulled downward by the rollers.

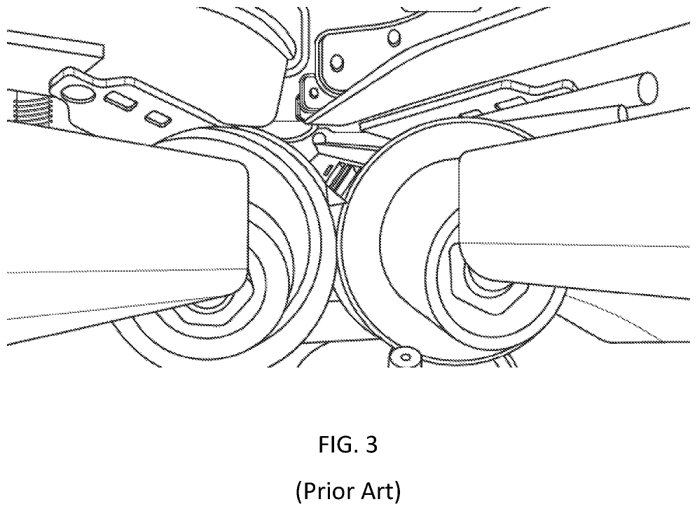

FIG. 3 shows a roller mechanism used with corn harvesting heads. As with the stripper plates, inter-snout space 130 is typically provided with a cooperating pair of roller mechanisms, specifically, a left roller mechanism 301a mounted to a first snout, and a right roller mechanism 301b mounted to an adjacent snout. The left roller mechanism cooperates with the right roller mechanism pull row crop stalks into the space between the snouts.

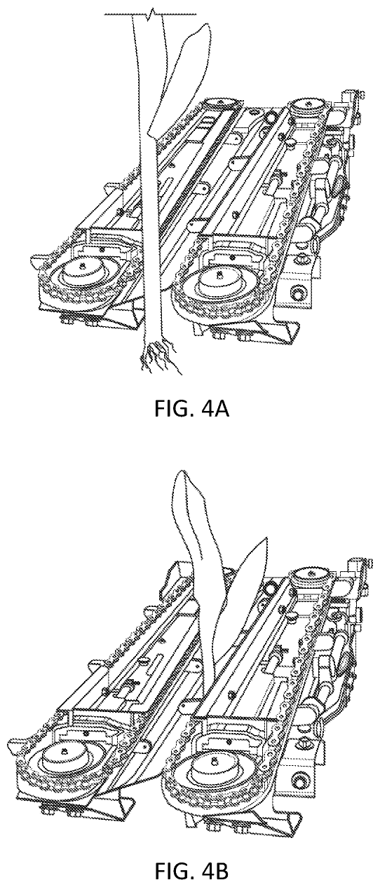

FIGS. 4A, 4B, 4C, and 4D show how corn stalks are pulled by the roller mechanism down past the stripper plates, and how the harvested corn ear is retained by the stripper plates before being moved to the combine storage bin. As the combine drives through the crop field, rows of crop pass through the inter-snout spaces 130 between adjacent snouts. As the crop stalks contact the rollers, the stalk is pulled downward away from the snout and toward the ground. This downward movement pulls the stalk past a cooperating pair of stripper plates, which strip the crop from the stalk. The spacing between the two members of the cooperating pair of stripper plates is such that the stalk may pass through the space between the stripper plates but the crop to be harvested may not. Accordingly, the harvested crop is retained by one or more of the stripper plate pieces where it is available to be moved to a storage bin.

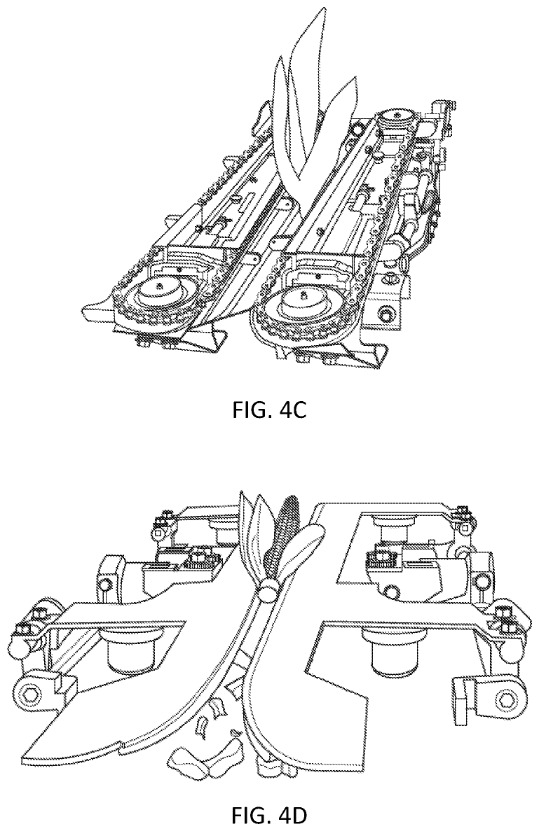

FIGS. 5A and 5B show an end sectional view of a prior art stripper plate assembly, with the two halves of the stripper plate being aligned with respect to the y-axis, and spaced apart with respect to the x-axis. As shown by the drawing, in the prior art assembly, the two stripper plate halves are positioned at substantially the same height above the ground. In three dimensional space, with the plane of the page being a plane along the y-axis (i.e, the bottom of the page is the x-axis and one sides of the page is the z-axis), both stripper plate halves are positioned along the same z coordinate Z₁. Further, there is a space between the two halves along the x-axis, i.e., one half ends at X₁ and the other half ends at X₂, with X₁ being different from X₂, and the space between X₁ and X₂ preferably being more than one inch, and optionally being more than two inches.

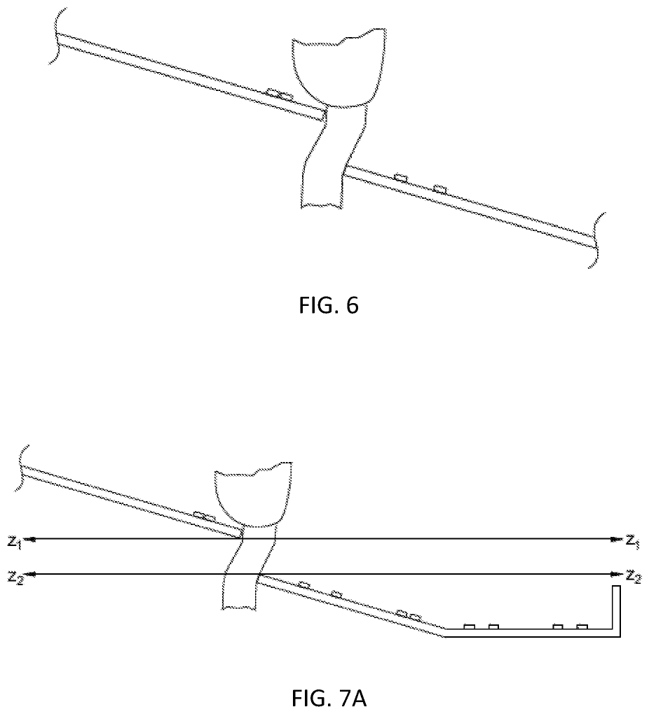

FIGS. 7A and 7B show an end sectional view of a stripper plate assembly according to one embodiment of the present invention, with one half of the stripper plate assembly being positioned above the other half with respect to the z-axis, and the two halves overlapping or being directly adjacent to each other with respect to the x-axis so that there is not a substantial space between the two halves along the x-axis. Using the terminology referenced above, the height of one assembly half is Z₁, and the height of the other stripper assembly half is Z₂, with Z₁ preferably being higher than Z₂, and the difference in height preferably being at least one inch. Similarly, there is little if any space between the two halves along the x-axis, with one half ending at X₁ and the other half ending at X₂, with space between X₁ and X₂ preferably being no more than 1.5 inches, and most preferably being less than one inch, or with the two halves overlapping on the X-axis so that the “space between” X₁ and X₂ is a negative number.

Each pair of adjacent stripper plate assembly halves comprises a first half 402 having a first stalk-contacting edge 412 and a first plate surface 414 extending away from that first stalk-contacting edge in a first direction D1, and a second half 403 having a second stalk-contacting edge 422 and a second plate surface 424 extending away from that second stalk-contacting edge in a second direction D2 opposite first direction D1. Second plate half 403 preferably extends to a trough portion 415 that preferably terminates in an upturned end 417 effective to retain harvested crop in the trough for movement to an auger.

In the inventive stripper plate assembly, each of the first stalk-contacting edges 412 is positioned on the harvesting head at a first stalk-contacting level L1, and each of said second stalk-contacting edges 422 is positioned on the harvesting head at a second stalk-contacting level L2, with the first stalk-contacting edge level L1 being higher (i.e., farther from the ground) than its corresponding second stalk-contacting edge level L2. Preferably L1 is between 0.5″ and 6″ higher than its corresponding second stalk-contacting level L2, and more preferably may be between 1″ and 3″ higher than its corresponding second stalk-contacting level L2.

Also in the inventive stripper plate assembly, each of the stalk-contacting halves is positioned on the harvesting head at a horizontal position Hₓ in which the first stalk-contacting edge overlaps, or is directly adjacent to, the second stalk-contacting edge. With this arrangement there is little or no horizontal gap between the two halves.

FIGS. 7A and 7B also show the lower half of the stripper plate assembly including a trough at its lower end to collect kernels and to pass them back to an auger.

As described above, each of the second plate surfaces slopes downward as it extends away from its stalk-contacting edge. Similarly, each of the first plate surfaces preferably slopes upward as it extends away from its stalk-contacting edge. With this arrangement, the stripper plate assembly slopes downward from the upper left edge to the lower right edge, thus providing a smooth pathway for crop to be directed to its initial collection area.

To facilitate collection of the crop, each of the second plate surfaces preferably extends away from its second stalk-contacting edge until it terminates in a trough portion. The trough may further slope backward toward an auger to facilitate collection of the crop.

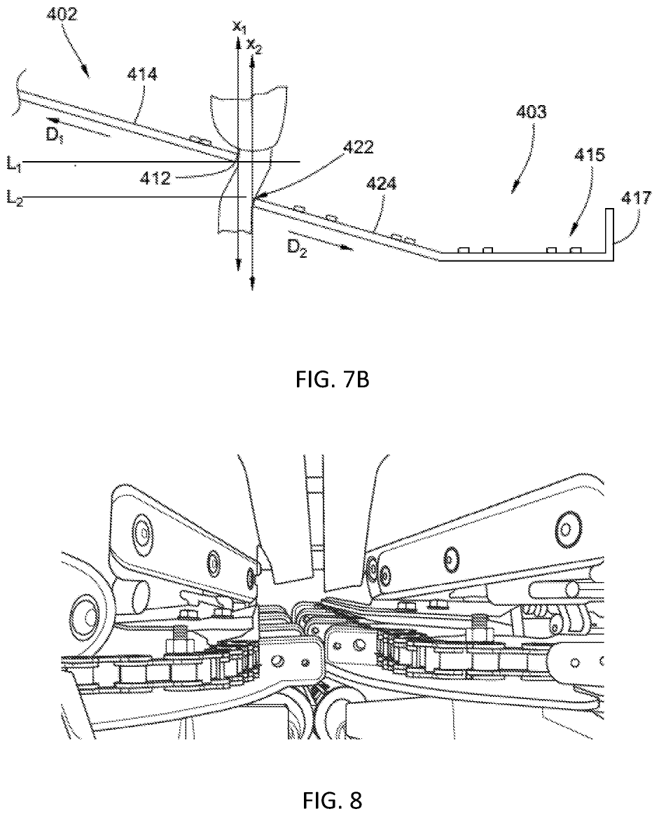

FIG. 8 shows a gathering mechanism that may be used with corn harvesting heads. The illustrated gathering mechanism is a gathering chain that pulls gathering paddles that sweep harvested crop from the stripper plates. Gathering chains 201 are effective for pulling row crop stalks into a space 206 between adjacent harvesting snouts. Typically space 206 is provided with two gathering chains, specifically, a left gathering chain 201a mounted to a first snout, and a right gathering chain 201b mounted to an adjacent snout. The left gathering chain of the first snout cooperates with the right gathering chain of the adjacent snout to pull harvested row crops through the space between the snouts and backward to an auger that moves the crop to a storage bin.

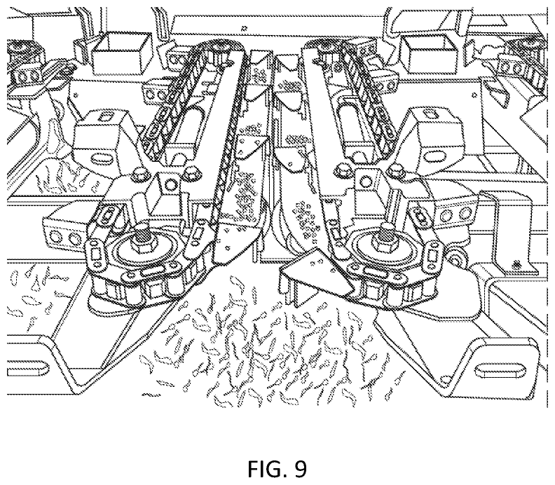

FIG. 9 shows how components mounted on the right-hand side or one snout cooperate with components mounted on the left-hand side of an adjacent snout to harvest a row crop.

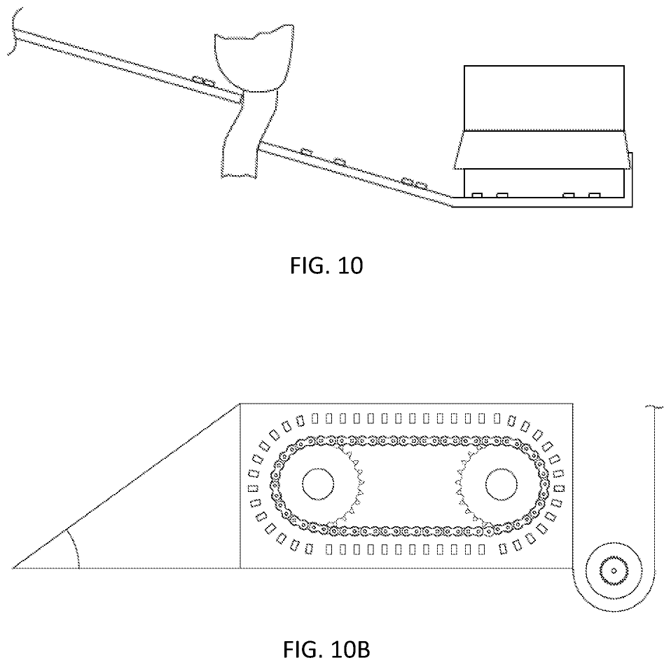

FIGS. 10A and 10B show one preferred embodiment of a gathering mechanism that may be used with the inventive corn harvesting heads. Gathering mechanism 400 includes paddles 410 that sweep harvested crop from the stripper plates, and preferably from a trough along a lower side of the lowermost stripper plate. The paddles may be driven by a chain or other mechanism, and may sweep harvested crop to an auger or other device effective to move harvested crop to a storage bin.

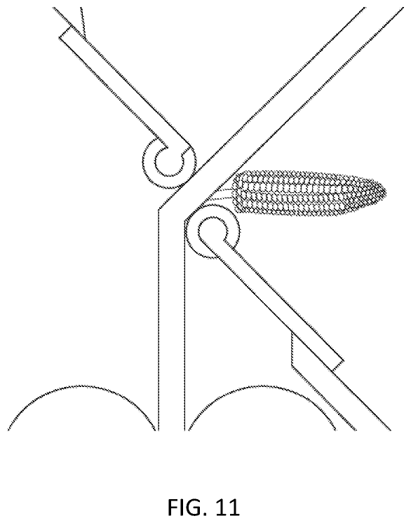

FIG. 11 shows one embodiment of a stripper roller mechanism useful with some embodiments of the present invention. In this embodiment, a roller mechanism is provided along the stalk-contacting side of the stripper assembly so that the crop is contacted by the roller instead of by a rigid plate edge. The rollers 601 and 602 of adjacent stripper assembly halves are positioned in substantially the same manner as the edges would be, if edges were used. The rollers are spaced such that leaves and small material (e.g., small pieces of stalk, etc.) may pass between the rollers and not be collected by the stripper assembly, while crop (e.g. ears of corn) does not pass between the rollers and is accordingly stripped from the stalk and is directed to the trough. This feature reduces the amount of waste material that is passed to the storage bin, without decreasing the amount of harvested crop.

While the invention has been illustrated and described in detail in the drawings and foregoing description, the same are to be considered as illustrative and not restrictive, it being understood that only certain preferred embodiments have been shown and described and that all changes and modifications that come within the spirit of the invention are desired to be protected. In addition, it is to be appreciated that the present invention may comprise or consist essentially of any or all of the described or illustrated features. For example, the present invention includes devices and methods comprising any or all of the features described or illustrated in specification or drawings, and the present invention includes devices and methods consisting essentially of any or all of the features illustrated in the specification or drawings. Additionally, any or all of the features and/or embodiments disclosed herein may be combined with any or all of the other features and/or embodiments disclosed herein to provide a device or method that comprises or consists essentially of such features.

Finally, the grammatical device “and/or” (such as in “A and/or B”) is used in this disclosure to mean A alone, or B alone, or both A and B. Additionally, the term substantial horizontal gap means a gap of at least two inches.

1. A row crop harvesting head mountable to a combine in a manner effective to harvest row crops in a field, the harvesting head comprising a plurality of spaced-apart harvesting snouts, roller mechanisms effective for pulling row crop stalks downward away from the harvesting head and toward the ground in a space between adjacent snouts, and a plurality of stripper plate assemblies effective for stripping the row crop from its stalks as the stalks are pulled downward past the stripper plates;
wherein each of said stripper plate assemblies comprises a pair of adjacent halves, with each pair of adjacent halves comprising a first half having a first stalk-contacting edge and a first plate surface extending away from said first stalk-contacting edge in a first direction, and a second half having a second stalk-contacting edge and a second plate surface extending away from said second stalk-contacting edge in a second direction opposite said first direction,
wherein each of said first stalk-contacting halves is positioned on the harvesting head at a first stalk-contacting level, and each of said second stalk-contacting halves is positioned on the harvesting head at a second stalk-contacting level, and each of said first stalk-contacting edge levels is higher from the ground than its corresponding second stalk-contacting edge level, and
wherein each of said stalk-contacting halves is positioned on the harvesting head at a horizontal position in which the first stalk-contacting edge overlaps or is directly adjacent the second stalk-contacting edge so that there is little or no horizontal gap between the two halves.

2. A row crop harvesting head according to claim 1 wherein each of said second plate surfaces includes a downward-sloping portion extending away from its stalk-contacting edge.

3. A row crop harvesting head according to claim 1 wherein each of said second plate surfaces includes a trough portion adjacent its downward-sloping portion opposite said stalk-contacting edge.

4. A row crop harvesting head according to claim 1 wherein each of said first plate surfaces slopes upward as it extends away from its stalk-contacting edge.

5. A row crop harvesting head according to claim 1 wherein each of said stalk-contacting halves is positioned on the harvesting head at a horizontal position in which the first stalk-contacting edge overlaps the second stalk-contacting edge so that there is no horizontal gap between the two halves.

6. A row crop harvesting head according to claim 3, and further including a gathering mechanism adapted to remove harvested crop from the harvesting head.

7. A row crop harvesting head according to claim 6 wherein said gathering mechanism comprises a gathering chain with rubber paddles effective to rake out the bottom of said trough.

8. A row crop harvesting head according to claim 7 wherein said gathering mechanism further comprises an auger effective to move harvested crop to a storage bin.

9. A row crop harvesting head according to claim 1 wherein each of said first stalk-contacting edge levels is at least 1″ higher from the ground than its corresponding second stalk-contacting edge level.

10. A row crop harvesting head according to claim 1 wherein each of said stalk-contacting halves is positioned on the harvesting head such that the horizontal gap between adjacent edges is less than 1″.
